(19) United States
(12) Patent Application Publication
(10) Pub. No.: US 2022/0317606 A1
(43) Pub. Date: Oct. 6, 2022

(54) FIXING DEVICE AND IMAGE FORMING APPARATUS

(71) Applicant: KYOCERA Document Solutions Inc., Osaka (JP)

(72) Inventors: Hiroki KAWASAKI, Osaka-shi (JP); Takashi EIKI, Osaka-shi (JP); Akihiro KONDO, Osaka-shi (JP); Ryohei TOKUNAGA, Osaka-shi (JP); Yuta KITABAYASHI, Osaka-shi (JP); Rina KIKUGAWA, Osaka-shi (JP); Shunsaku FUJII, Osaka-shi (JP); Tei TO, Osaka-shi (JP)

(73) Assignee: KYOCERA Document Solutions Inc., Osaka (JP)

(21) Appl. No.: 17/704,506

(22) Filed: Mar. 25, 2022

(30) Foreign Application Priority Data
Mar. 30, 2021 (JP) 2021-057162

(51) Int. Cl. G03G 15/20

(52) U.S. Cl. CPC G03G 15/2053

(57) ABSTRACT

A fixing belt heats and fixes a toner image formed on a sheet. A plurality of heating element pieces is arranged on an opposing surface of a heater in a main scanning direction. The opposing surface faces the sheet. A heat capacity of the fixing belt and a clearance, in the main scanning direction, of a gap portion between the heating element pieces adjacent to each other have a relationship expressed as follows:

(the heat capacity (J/K) of the fixing belt)≥(24×(the clearance (mm))−9).

### INCORPORATION BY REFERENCE

The present application claims priority under 35 U.S.C. § 119 to Japanese Patent Application No. 2021-057162, filed on Mar. 30, 2021. The contents of this application are incorporated herein by reference in their entirety.

### BACKGROUND

The present disclosure relates to a fixing device and an image forming apparatus.

A fixing device generally suppresses unnecessary heating of a non-media-handling section.

### SUMMARY

The fixing device according to the present disclosure includes a fixing belt, a heater, and a plurality of heating element pieces. The fixing belt heats and fixes a toner image formed on a sheet. The heater heats the fixing belt. The heating element pieces are arranged on an opposing surface of the heater in a main scanning direction. The opposing surface faces the sheet. A heat capacity of the fixing belt and a clearance, in the main scanning direction, of each gap portion between the heating element pieces adjacent to each other have a relationship expressed as follows:

(the heat capacity (J/K) of the fixing belt)≥(24×(the clearance (mm))−9).

### BRIEF DESCRIPTION OF THE DRAWINGS

FIG. 1 is a diagram illustrating a multifunction peripheral including a fixing device and an image forming apparatus, according to an embodiment of present disclosure.

FIG. 2 is a block diagram illustrating a configuration of the image forming apparatus including the fixing device in the present embodiment.

FIG. 3 is a cross-sectional view illustrating a configuration of the fixing device according to the present embodiment.

FIG. 4 is a plan view illustrating a heater of the fixing device according to the present embodiment.

FIGS. 5A and 5B are a plan view and a side view respectively illustrating the heater of the fixing device according to the present embodiment.

FIG. 6 is a graph showing a relationship between a heat capacity of the fixing belt and a clearance, in a main scanning direction, of each gap portion between the heating element pieces adjacent to each other.

### DETAILED DESCRIPTION

The following describes an embodiment of the present disclosure with reference to the accompanying drawings. Note that elements which are the same or equivalent are labeled the same reference signs in the drawings and description thereof is not repeated. In the present embodiment, some drawings illustrate X, Y, and Z-axes orthogonal to each other. The Z-axis is parallel to a vertical plane, and the X and Y-axes are parallel to a horizontal plane.

In the present embodiment, a Y-axial direction may be described as a “main scanning direction”. A Z-axial direction may be described as a “sub-scanning direction”. An X-axial direction may be described as a “direction orthogonal to the main scanning direction and the sub-scanning direction”.

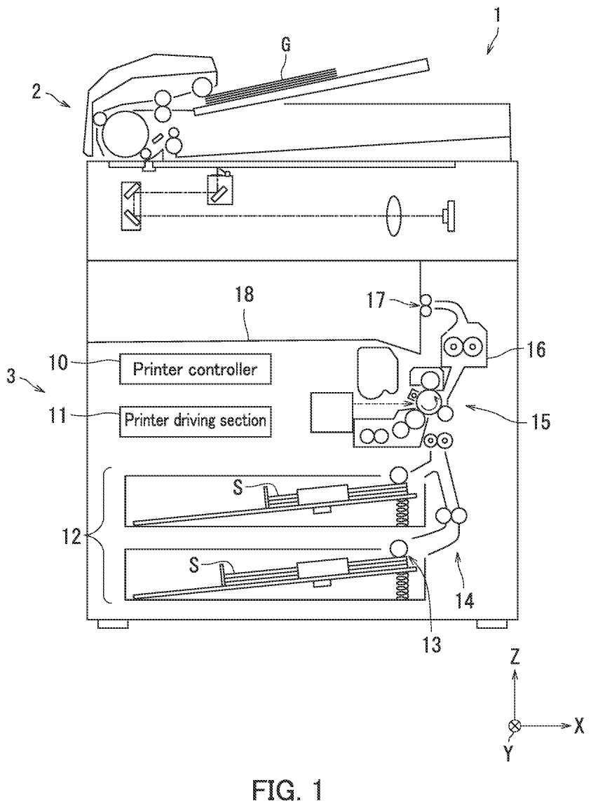

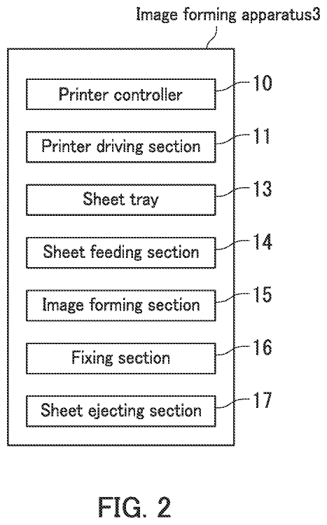

The following describes a configuration of a multifunction peripheral 1 with reference to FIG. 1. FIG. 1 is a diagram illustrating a multifunction peripheral 1 including a fixing device 16 according to the present embodiment. The following also describes a configuration of an image forming apparatus 3 including the fixing device 16 in the present embodiment with reference to FIG. 2. FIG. 2 is a block diagram illustrating a configuration of the image forming apparatus 3 including the fixing device 16 in the present embodiment.

As illustrated in FIG. 1, the multifunction peripheral 1 includes a document reading device 2 and the image forming apparatus 3. The multifunction peripheral 1 is a multifunction printer (MFP) which consolidates the functionalities of a scanner, a copier, a printer, and a facsimile machine, for example.

The document reading device 2 may include a document feed tray, a document feed section, a document conveyance section, a document reading section, an optical member, a document ejection section, and a document exit tray, for example.

The image forming apparatus 3 includes a printer controller 10, a printer driving section 11, sheet trays 12, sheet feeding sections 13, a sheet conveyance section 14, an image forming section 15, a fixing section 16 (fixing device 16), a sheet ejecting section 17, and a sheet exit tray 18.

The printer controller 10 controls the operation of each section of the image forming apparatus 3. The printer controller 10 may also control the operation of each section of the multifunction peripheral 1. Specific examples of the printer controller include a central processing unit (CPU), a microprocessor unit (MPU), and an application-specific integrated circuit (ASIC).

The printer controller 10 can select the size of a sheet S to be fed to the fixing device 16. The printer controller 10, in accordance with a job instruction, selects the size of the sheet S and instructs the sheet feeding section 13 to feed the sheet S having the selected size.

The printer driving section 11 drives each section of the image forming apparatus 3. The printer driving section 11 may also operate each section of the multifunction peripheral 1. Specific examples of the printer driving section 11 include an electric motor, an electromagnetic solenoid, a hydraulic cylinder, and a pneumatic cylinder.

The sheet tray 12 accommodates a recording medium in a stacked state. The recording medium is a sheet S, for example. The sheet tray 12 may include a tray and a lifting member. The sheet feeding section 13 picks up the sheet S stacked on the sheet tray 12 to feed the sheet S. The sheet feeding section 13 may be a pickup roller, for example.

The sheet conveyance section 14 conveys the sheet S fed from the sheet tray 12. The sheet conveyance section 14 has a conveyance path. The conveyance path extends from the sheet tray 12 to the sheet ejecting section 17 via the image forming section 15 and the fixing section 16. A conveyance roller and a registration roller may be disposed in the conveyance path of the sheet conveyance section 14.

A plurality of conveyance rollers may be disposed in the conveyance path to convey the sheet S. The registration roller adjusts the timing at which the sheet S is conveyed to the image forming section 15. The sheet conveyance section 14 conveys the sheet S from the sheet tray 12 to the sheet ejecting section 17 via the image forming section 15 and the fixing section 16.

The image forming section 15 electrographically forms a toner image (not shown) on the sheet S based on document image data. The document image data indicates an image of a document Q for example.

The fixing section 16 applies heat and pressure to the toner image transferred to the sheet S to fix the toner image on the sheet S. The fixing section 16 may be referred to as a “fixing device 16”.

The sheet ejecting section 17 ejects the sheet S out of the housing of the multifunction peripheral 1 (image forming apparatus 3). A specific example of the sheet ejecting section 17 is a discharging roller.

The sheet exit tray 18 holds the sheet S ejected by the sheet ejecting section 17.

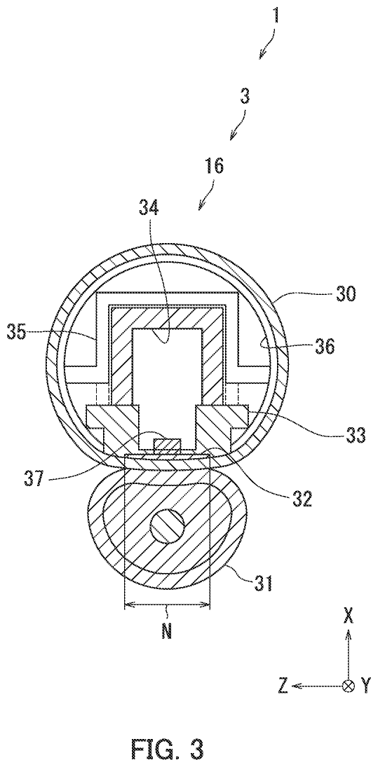

A configuration of the fixing device 16 according to the present embodiment will now be described in detail with reference to FIG. 3. FIG. 3 is a cross-sectional view illustrating the configuration of the fixing device 16 according to the present embodiment.

As illustrated in FIG. 3, the fixing device 16 includes a fixing belt 30, a pressure member 31, a heater 32, a heater holding member 33, a sheet metal stay 34, a sheet metal stay holding section 35, a fixing belt holding section 36, and a temperature measuring section 37.

The fixing belt 30 heats and fixes the toner image formed on the sheet S. Specifically, when the sheet S (FIG. 1), on which the toner image is formed by the image forming section 15 illustrated in FIG. 1, is conveyed to the fixing device 16, the fixing belt 30 heats and fixes the toner image transferred to the sheet S.

The fixing belt 30 illustrated in FIG. 3 is an endless belt. The fixing belt 30 which has a substantially cylindrical shape, is flexible.

The fixing belt 30 includes a plurality of layers. For example, the fixing belt includes a polyimide layer containing polyimide, an elastic layer containing an elastic material such as silicone rubber, and a mold release layer. The mold release layer is formed on an outer circumferential surface of the polyimide layer. The mold release layer is a heat resistant fluororesin film, for example.

The pressure member 31 rotates while pressing against (comes into contact with) the fixing belt 30, thereby causing the fixing belt 30 to passively rotate. The pressure member 31 which has a substantially cylindrical shape, is disposed opposite to the fixing belt 30. The pressure member 31 is a pressure roller 31, for example. In the following, the pressure member 31 may be referred to as “pressure roller 31”.

The pressure roller 31 includes a columnar metal core, a cylindrical elastic layer, and a mold release layer. The elastic layer is formed on the metal core. The mold release layer covers the surface of the mold release layer.

The metal core is made from stainless steel or aluminum, for example. The elastic layer is formed of silicone rubber, for example. The mold release layer is formed of fluororesin, for example.

The heater 32, which is connected to a power supply (not shown), generates heat for heating the fixing belt 30. The heater 32 is located opposite to the inner peripheral surface of the fixing belt 30. The heater 32 may be pressed toward the inner peripheral surface of the fixing belt 30 by a pressing member (not shown).

The heater 32 may be a film heater or an elongated thin plate heater. For example, the heater 32 is a ceramic heater, which includes a ceramic substrate and a resistive heating element. The heater 32 is 1 mm thick, for example. The heater 32 receives pressure from the pressure roller 31 through the fixing belt 30.

A nip part N is formed at a contact section between the fixing belt 30 and the pressure roller 31 as the pressure roller 31 presses against the fixing belt 30. The heater 32 is in contact with the inner peripheral surface of the fixing belt 30 as the pressure roller 31 presses against the fixing belt 30. As a result, the fixing belt 30 which is heated by the heater 32, fixes the toner image formed on the sheet S (FIG. 1) passing through the nip part N, to the sheet S.

A lubricating oil is applied to the inner peripheral surface of the fixing belt 30. The lubricating oil is interposed between the fixing belt 30 and the heater 32. The lubricating oil forms a lubricating film between the inner peripheral surface of the fixing belt 30 and the heater 32. The lubricating oil reduces friction between the fixing belt and the heater 32.

The lubricating oil is grease, for example. Grease which has higher viscosity η than oil and hardly flow, is semi-solid or semi-fluid at room temperature. For example, grease is semi-solid or solid lubricant formed as an even dispersion of thickening agents in a liquid lubricant. The thickening agents may be calcium, sodium, lithium or aluminum soap (fatty acid salt).

The heater holding section 33 holds the heater 32 heating the fixing belt 30 and supports the fixing belt 30 to be rotatable.

The sheet metal stay 34 reinforces the heater holding section 33. The sheet metal stay 34 is an elongated metal stay member, for example. The sheet metal stay 34 may be formed in a square bracket shape, a U-shape, or a V-shape.

The sheet metal stay holding section 35 holds the sheet metal stay 34 to fix the sheet metal stay 34 to the heater holding member 33.

The fixing belt holding section 36 holds the fixing belt 30 to be rotatable about the fixing belt holding section 36.

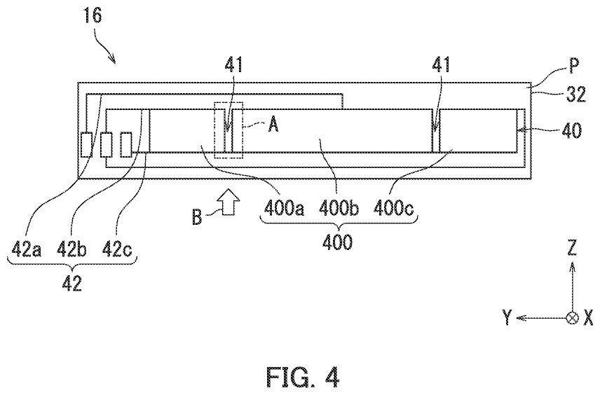

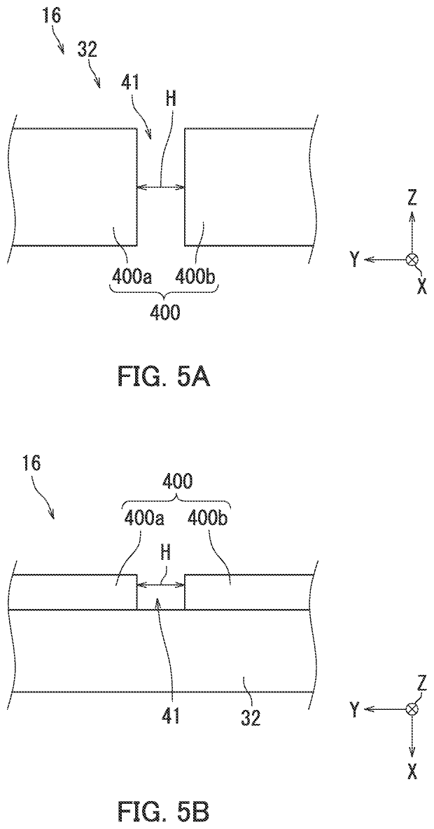

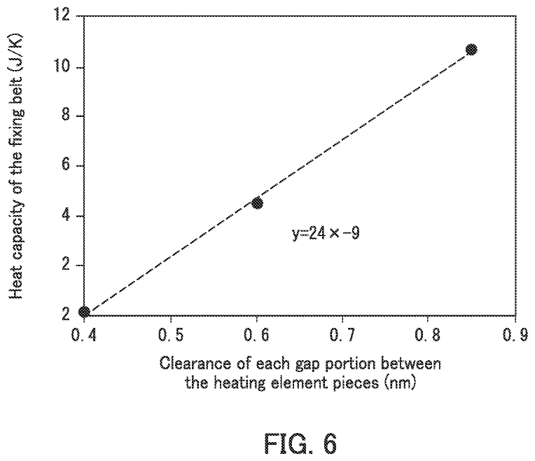

The following describes a configuration of the heater 32 in detail with reference to FIGS. 4 to 6. FIG. 4 is a plan view illustrating the heater 32 of the fixing device 16 according to the present embodiment. FIGS. 5A and 5B are a plan view and a side view respectively illustrating the heater 32 of the fixing device 16 according to the present embodiment. FIG. 6 is a graph showing a relationship between a heat capacity of the fixing belt 30 and a clearance H, in main scanning direction, of each gap portion 41 between the heating element pieces 400 adjacent to each other.

Referring to FIG. 4, the heater 32 includes a heating element, which is connected to electrodes 42. The electrodes 42 are connected to a power supply (not shown) to supply electric power to the heating element 40.

The heating element 40 heats the fixing belt 30 through Joule heat generated by the supply of electric power from the power supply (not shown) via the electrodes 42.

The heating element 40 extends in the main scanning direction. The heating element 40 whose resistivity is higher than materials of the electrodes 42, may be a resistance heating element such as silver palladium (Ag/Pd), ruthenium oxide (RuO₂), and tantalum nitride (Ta₂N), for example.

The heating element 40 is formed by printing a thick film of ruthenium oxide paste and then firing it, for example. Alternatively, formation of the heating element may utilize thin film technology such as sputtering.

For example, the electrodes 42 are made from resinate Au with additive elements such as rhodium, vanadium, bismuth, and silicon. The electrodes 42 may be formed by printing a thick film of resinate Au paste and then firing it. Formation of the electrodes 42 may also utilize thin film technology such as sputtering. The electrodes 42 may be configured by stacking a plurality of Au layers.

As illustrated in FIG. 4, the electrodes 42 includes an electrode 42a, an electrode 42b, an electrode 42c, and the like. A first heating element piece 400b is connected to the electrodes 42a and 42c. A second heating element piece 400a is connected to the electrodes 42b and 42c. A second heating element piece 400c is also connected to the electrodes 42b and 42c. The electrodes 42 are connected to a power supply (not shown) to supply electric power to each of the heating element pieces 400.

The electrode 42a is connected to a downstream side of the first heating element piece 400b in the sub-scanning direction, and extends in the main scanning direction parallel to the first heating element piece 400b. The electrode 42b is connected to a respective downstream side of the second heating element pieces 400a and 400c in the sub-scanning direction, and extends in the main scanning direction parallel to the second heating element pieces 400a and 400c. The electrode 42c is connected to a respective downstream side of the first heating element piece 400b and the second heating element pieces 400a and 400c in the sub-scanning direction, and extends in the main scanning direction parallel to the first heating element piece 400b and the second heating element pieces 400a and 400c.

The heating element 40 (heating element pieces 400) heats the fixing belt 30 through Joule heat generated by the supply of electric power from the power supply (not shown) via the electrodes 42.

The heater 32 of the fixing device 16 according to the present embodiment includes a plurality of heating element pieces 400. Specifically, the heater 32 includes the heating element 40, which includes a plurality of heating element pieces 400. The heating element pieces 400 may include a first heating element piece 400b, a second heating element piece 400a, a second heating element piece 400c, and the like. The heating element pieces 400 are arranged on an opposing surface P of the heater 32 in the main scanning direction. The opposing surface faces the sheet S.

For example, a small size sheet S passes through the first heating element piece 400b in fixing process. A middle size or large size sheet S passes through the first heating element piece 400b, and the second heating element pieces 400a and 400c in fixing process.

A gap portion 41 is provided between the first heating element piece 400b and the second heating element piece 400a. A gap portion 41 is also provided between the first heating element piece 400b and the second heating element piece 400c.

The fixing belt 30 includes a base layer, an elastic layer, and a mold release layer, for example. In present embodiment, the fixing belt 30 may include the base layer and the mold release layer and exclude the elastic layer. Exclusion of the elastic layer in the fixing belt 30 of the fixing device 16, may cause the image forming apparatus 3 to be compact or at a reasonably low cost. The fixing belt 30 excluding the elastic layer may have lower heat capacity than the fixing belt 30 including the elastic layer.

Low heat capacity results in a rapid increase or decrease in temperature of the fixing belt 30 excluding the elastic layer while start or stop of heating by the heater 32. As such, the decrease in temperature of the gap portion 41 in the fixing belt 30 excluding the elastic layer may be greater than that of in the fixing belt 30 including the elastic layer. Therefore, the image forming apparatus 3 whose fixing belt 30 excludes the elastic layer is more likely to have an image defect on the sheet S, when compared with the image forming apparatus 3 whose fixing belt 30 includes the elastic layer.

FIG. 5A is an enlarged view of a range A indicated by a dotted line in FIG. 4. FIG. 5B is a side view of the range A illustrated by the dotted line in FIG. 4 as viewed from the direction of the arrow B in FIG. 4.

As shown in FIGS. 5A and 5B, the gap portion 41, which is formed between the first heating element piece 400b and the second heating element piece 400a adjacent to each other, has a clearance H (mm) in the main scanning direction.

Referring to FIG. 6, the heat capacity (J/K) of the fixing belt 30 and the clearance H (mm), in the main scanning direction, of each gap portion 41 between the heating element pieces 400 adjacent to each other have a relationship expressed by Expression 1 as follows:

(the heat capacity (J/K) of the fixing belt)≥(24×(the clearance (mm))−9).

An experiment conducted by the discloser revealed a result that the decrease in temperature of each gap portion 41 between the heating element pieces 400 had been suppressed, when the clearance H of each gap portion 41 between the heating element pieces 400 adjacent to each other was 0.85 (mm), and the heat capacity of the fixing belt was 11 (J/K) or more. As a result, a toner image formed on the sheet S was properly fixed to the sheet S, and image defects on the sheet S were eliminated.

The experimental result also revealed that image defects on the sheet S were eliminated, when the clearance H of each gap portion 41 between the heating element pieces 400 adjacent to each other was 0.6 (mm), and the heat capacity of the fixing belt was 5 (J/K) or more.

A boundary value for preventing the image defects from occurring on the sheet S was derived from the relationship (Expression 1) between the clearance H of each gap portion 41 and the heat capacity of the fixing belt 30 based on these experimental results.

In the present embodiment, the heat capacity of the fixing belt 30 is preferably within the range of 5 (J/K) to 10 (J/K).

In the present embodiment, more preferably, the heat capacity of the fixing belt is 10 (J/K).

In the present embodiment, the clearance H is preferably within the range of 0.5 (mm) to 0.85 (mm).

An experiment conducted by using an image forming apparatus 3 of the discloser revealed a result that the image quality was the best when the heat capacity of the fixing belt 30 was 10 (J/K), and the clearance H of each gap portion 41 was 0.5 (mm).

In the present embodiment, the clearance H is preferably 0.5 (mm).

According to the present embodiment, satisfaction of the conditions indicated by Expression 1 results in a reduction of the decreasing in temperature of each gap portion 41 between the heating element pieces 400. Accordingly, the toner image formed on the sheet S can be properly fixed to the sheet S, and image defects on the sheet S can be eliminated.

According to the present embodiment, elimination of image defects on the sheet S can also be achieved in the image forming apparatus 3 whose fixing belt 30 excludes the elastic layer.

According to the present embodiment, it is possible to obtain the heat capacity of the fixing belt 30 and the clearance H of each gap portion 41 between the heating element pieces 400, which enhance the image quality.

An embodiment of the present disclosure has been described above with reference to the accompanying drawings. However, the present disclosure is not limited to the above embodiment and can be implemented in various manners within a scope not departing from the gist thereof. The drawings mainly illustrate various constituent elements schematically for ease of understanding. Aspects such as thickness, length, and number of the constituent elements illustrated in the drawings may differ in practice for convenience of drawing preparation. Furthermore, aspects such as material, shape, and dimension of the constituent elements illustrated in the above embodiment are one example and not particular limitations.

What is claimed is:

1. A fixing device, comprising
a fixing belt which heats and fixes a toner image formed on a sheet;
a heater which heats the fixing belt; and
a plurality of heating element pieces which is arranged on an opposing surface of the heater in a main scanning direction, wherein the opposing surface faces the sheet; and
a heat capacity of the fixing belt and a clearance, in the main scanning direction, of a gap portion between the heating element pieces adjacent to each other have a relationship expressed as follows:
(the heat capacity (J/K) of the fixing belt)≥(24×(the clearance (mm))−9).

2. The fixing device according to claim 1, wherein
the heat capacity of the fixing belt is within a range of 5 (J/K) to 10 (J/K).

3. The fixing device according to claim 1, wherein
the heat capacity of the fixing belt is 10 (J/K).

4. The fixing device according to claim 1, wherein
the clearance is within a range of 0.5 (mm) to 0.85 (mm).

5. The fixing device according to claim 1, wherein
the clearance is 0.5 (mm).

6. The fixing device according to claim 1, wherein
the fixing belt includes a base layer and a mold release layer, and excludes an elastic layer.

7. An image forming apparatus comprising
the fixing device according to claim 1.
